(19) United States
(12) Patent Application Publication
(10) Pub. No.: US 2010/0093883 A1
(43) Pub. Date: Apr. 15, 2010

(54) Hydroxamic Esters as Photoinitiators

(75) Inventors: Angelo Casiraghi, Milano (IT); Marco Visconti, Varese (IT); Gabriele Norcini, Comabbio (VA) (IT); Celine Dietlin, Mulhouse Cedex (FR); Xavier Allonas, Mulhouse Cedex (FR); Jean Pierre Fouassier, Mulhouse Cedex (FR); Giuseppe Li Bassi, Gavirate (VA) (IT)

Correspondence Address: Mossman, Kumar & Tyler PC, P.O. Box 421239, Houston, TX, 77242, US

(73) Assignee: Lamberti SpA, Albizzate (IT)

(21) Appl. No.: 12/529,533

(22) PCT Filed: Jan. 31, 2008
(86) PCT No.: PCT/EP08/51183

§ 371 Date: Sep. 1, 2009

(30) Foreign Application Priority Data
Mar. 1, 2007 (IT) VA2007A000023

(51) Int. Cl. C08F 2/50

(52) U.S. Cl. 522/53

(57) ABSTRACT

The present invention concerns photopolymerisable systems comprising reactive oligomers and/or monomers having ethylenically unsaturated groups and as photoinitiator at least one hydroxamic ester of Formula (I) or (II) or (III).

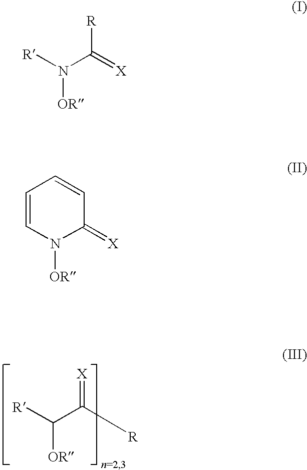

### TECHNICAL FIELD

This invention concerns photopolymerisable systems containing hydroxamic esters that, by photochemical decomposition, generate fragments capable of inducing the radical photopolymerisation of oligomers and/or monomers having ethylenically unsaturated groups; the photopolymerisable systems are useful for the UV curing of coating formulations and photolithography.

### BACKGROUND ART

Photoelimination reactions and homolytic cleavage of ketones have been thoroughly investigated by organic chemists since the beginning of the last century.

Nonetheless, relatively few compounds different from aromatic ketones, beside generating radical fragments, are able to initiate photopolymerisation of ethylenically unsaturated compounds and are useful as photoinitiators in UV curing coating formulations.

Among these, we cite for example camphorquinone, metallocenes, aromatic phenylglyoxylic acid esters and acylphosphine oxides, which are well known photoinitiators for radiation curable resins.

From the literature it is known that hydroxamic acid and its esters undergo photoelimination to give benzamide (Photochemistry and Photobiology, 51 (2), 139-144, 1990); in Tetrahedron, 44 (18), 5857-5860, 1988, the photochemical and thermal reactions of 2-aryloxybenzohydroxamic acids are also described.

In addition some keto-oxime esters derivatives, like Irgacure OXE01® (see formula here below)

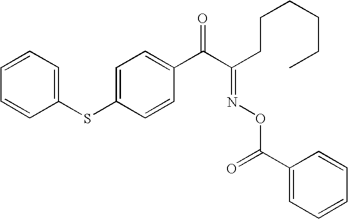

and oxime ester derivatives as described in US 2001/0012596 are suitable photoinitiators in photopolimerizable compositions for a wide range of applications including photoresists for electronics.

It is also known that some hydroxamic esters are able to generate radicals under thermal treatment or by light radiation, but as far as the Applicant knows, the use of hydroxamic esters as photoinitiators in UV photocurable systems for coating or photolithography is not known in the practice.

EP 1 617 288 reports the use of N-oxyamide compounds in photosensitive compositions for lithographic printing plates that also contain a photoinitiator; the N-oxyamide compounds are said to enhance the photosensitivity of the system, the interactions with the photoinitiator, sensitivity and stability in ageing.

### DISCLOSURE OF INVENTION

It has now been found that specific hydroxamic esters act by themselves as photoinitiators, i.e. they generate by themselves, by photochemical decomposition, fragments which are capable of inducing the radical photopolymerisation of ethylenically unsaturated monomers and oligomers; it has also been found that the polymerisation rate that is obtained in the presence of said specific hydroxamic esters makes them suitable for use in coatings and photolithography.

In the present application, with the expression “hydroxamic esters” we indicate both hydroxamic esters (R(C═O)N(R′)OH and R(C═O)N(R′)OR″) and thiohydroxamic esters (R(C═S)N(R′)OH and R(C═S)N(R′)OR″).

The hydroxamic esters useful for the realisation of the present invention have formula I:

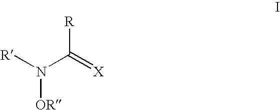

wherein X is O or S;

R is phenyl or phenyl which is substituted with one ore more C₁-c₁₂ linear or branched alkyl or cycloalkyl, c₁-c₄ haloalkyl, halogen, nitro, cyano, phenyl, benzyl, OR₀, NR₁R₂, SR₃, benzoyl, S(═O)-phenyl, S(═O)₂-phenyl and/or S-phenyl, the substituents OR₀, NR₁R₂, SR₃, possibly forming 5- or 6-membered rings, via the radicals R₀, R₁, R₂, and/or R₃, or with further substituents on the phenyl ring or with one of the carbon atoms of the phenyl ring,

or R is

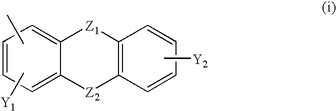

where Z₁ and Z₂, are independently of each other single bond, S, O, S═O, S(═O)₂, C═O, C═S, NR₁, C(═N)R₁, C₁-C₂ alkylene which is unsubstituted or substituted with c₁-c₁₂ alkyl, and Y₁ and Y₂, are independently of each other C₁-c₁₂ linear o branched alkyl, c₁-c₄ haloalkyl, cycloalkyl, halogen, phenyl, benzyl, OR₀, NR₁R₂, SR₃, benzoyl, S(═O)-phenyl, S(═O)₂-phenyl and/or S-phenyl, the substituents OR₀, NR₁R₂, SR₃ possibly forming 5- or 6-membered rings via the radicals R₀, R₁, R₂ and/or R₃, or with further substituents on the phenyl ring or with one of the carbon atoms of the phenyl ring, and the radicals C₁-c₁₂ alkyl, c₁-c₄ haloalkyl, phenyl possibly being substituted with a (C═O)N(R′)OR″ group,

or R is naphthyl, anthracyl, phenanthryl, the radicals naphthyl, anthracyl and phenanthryl being unsubstituted or substituted with one or more C₁-C₆ linear or branched alkyl or cycloalkyl, phenyl, OR₀, NR₁R₂, SR₃ and/or S-phenyl, the substituents OR₀, NR₁R₂, SR₃ possibly forming 5- or 6-membered rings, via the radicals R₀, R₁, R₂ and/or R₃, or with further substituents on the naphthyl, anthracyl or phenanthryl ring or with one of the carbon atoms of the naphthyl, anthracyl or phenanthryl ring,

or R is a 5- or 6-membered heterocyclic unsaturated radical comprising one or two heteroatoms selected from O, S and N, which is unsubstituted or substituted with C₁-C₆ alkyl, phenyl, OR₀, NR₁R₂, SR₃ and/or S-phenyl, the substituents OR₀, NR₁R₂, SR₃ possibly forming 5- or 6-membered rings via the radicals R₀, R₁, R₂ and/or R_{3,} or with further substituents on the heterocyclic unsaturated radical or with one of the carbon atoms of the heterocyclic unsaturated radical;

R′ is a C₁-C₁₂ linear or branched alkyl group or cycloalkyl which is unsubstituted or substituted with OH, C₁-C₄ alkoxy, SH, NR₁R₂, phenyl, benzyl, benzoyl, C₁-C₁₂ alkylsulfonyl, phenylsulfonyl, (4-methylphenyl)sulfonyl and/or C₁-C₆ alkanoyl, or C₅-C₈ cycloalkyl,

or R′ is C₂-C₁₂ alkyl interrupted by one or more -O-, said interrupted C₂-C₁₂ alkyl being unsubstituted or substituted with OH, C₁-C₄ alkoxy, C₁-C₁₂ alkylsulfonyl, phenylsulfonyl, (4-methylphenyl) sulfonyl and/or C₁-C₆ alkanoyl,

or R′ is phenyl, or phenyl which is substituted with one or more C₁-c₁₂ alkyl, C₅-C₈ cycloalkyl , c₁-c₄ haloalkyl, halogen, phenyl, OR₀, NR₁R₂, SR₃, benzoyl, S(═O)-phenyl, S(═O)₂-phenyl and/or S-phenyl, the substituents OR₀, NR₁R₂, SR₃ possibly forming 5- or 6-membered rings, via the radicals R₀, R₁, R₂ and/or R₃, or with further substituents on the phenyl ring or with one of the carbon atoms of the phenyl ring;

R″ has one of the meaning of R′,

or R″ is (C═O)R′″, and R′″ has one of the meaning of R′ or R′″ is a C₁₃-C₁₈ linear or branched alkyl group or cycloalkyl;

or R″ is a C₁-C₁₈ linear or branched alkyl sulfochloride or cycloalkyl sulfochloride or phenyl sulfochloride wherein the phenyl is unsubstituted or substituted with one or more C₁-C₁₂ alkyl, C₅-C₈ cycloalkyl , C₁-C₄ haloalkyl, halogen, phenyl, OR₀, NR₁R₂, SR₃, benzoyl and S-phenyl;

R₀ is hydrogen, phenyl, benzyl, C₁-C₁₂ alkyl unsubstituted or substituted with phenyl, benzyl, benzoyl, OH, C₁-C₁₂ alkoxy, C₁-C₁₂ alkylsulfonyl, phenylsulfonyl, (4-methylphenyl)sulfonyl and/or by C₂-C₆ alkanoyl,

or R₀ is C₂-C₁₂ alkyl interrupted by one or more —O—, said interrupted C₂-C₁₂ alkyl being unsubstituted or substituted with phenyl, OH, C₁-C₁₂ alkoxy, C₁-C₁₂ alkylsulfonyl, phenylsulfonyl, (4-methylphenyl)sulfonyl and/or by C₂-C₆ alkanoyl;

R₁ and R₂ independently of one another are hydrogen, C₁-C₁₂ alkyl which is unsubstituted or substituted by OH, C₁-C₄ alkoxy, C₁-C₁₂ alkylsulfonyl, phenylsulfonyl, (4-methylphenyl)sulfonyl and/or C₁-C₆ alkanoyl,

or R₁ and R₂ are C₂-C₁₂ alkyl or cycloalkyl interrupted by one or more —O—, said interrupted C₂-C₁₂alkyl being unsubstituted or substituted with OH, C₁-C₄ alkoxy, C₁-C₁₂ alkylsulfonyl, phenylsulfonyl, (4-methylphenyl)sulfonyl and/or C₁-C₆ alkanoyl,

or R₁ and R₂ are phenyl, C₂-C₆ alkanoyl, benzoyl, C₁-C₆ alkylsulfonyl, phenylsulfonyl, (4-methylphenyl)sulfonyl, naphthylsulfonyl, anthracylsulfonyl or phenanthrylsulfonyl,

or R₁ and R₂, together with the nitrogen atom to which they are bonded, form a 5-, 6- or 7-membered ring which may be interrupted by —O—, —S— or by —NR₀;

R₃ is C₁-C₁₂ alkyl which is unsubstituted or substituted with OH and/or C₁-C₄ alkoxy,

or R₃ is C₂-C₁₂ alkyl interrupted by one or more —O—, said interrupted C₂-C₁₂ alkyl being unsubstituted or substituted with OH and/or C₁-C₄ alkoxy.

The useful hydroxamic ester are also those of formula II

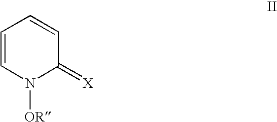

wherein X is S or O and R″ has the meaning detailed above,

and those of formula III

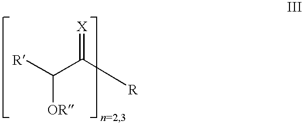

wherein R, R′, R″ and X have the meaning detailed above.

Photopolymerisable systems comprising radically photopolimerisable oligomers and/or monomers having ethylenically unsaturated groups and, as photoinitiator, at least one hydroxamic ester of formula I or II or III are a fundamental object of the present invention, and are particularly useful for the preparation of clear coatings, inks and lithographic systems.

Preferably, the useful hydroxamic esters have formula I or II, and more preferably in formula I X is O and in formula II, X is S.

The hydroxamic ester of formula I, wherein X is O, R is

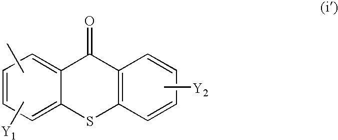

and Y₁ and Y₂, are independently of each other C₁-c₁₂ linear o branched alkyl, c₁-c₄ haloalkyl, cycloalkyl, halogen, phenyl, benzyl, OR₀,

and the hydroxamic esters of formula II wherein X is S and R″ is (C═O)R′″, with R′″ C₃-C₆ secondary alkyl or C₅-C₆ cycloalkyl, are particularly preferred for the realisation on the present invention, when used as the sole photoinitiators of the system, because they impart to the photopolymerisable systems high polymerisation and conversion rates; these hydroxamic esters are a further object of the present invention.

Unexpectedly, the hydroxamic esters of formula I or II or III may be used in the photopolymerisable system as the sole photoinitiators.

It has also been found that the hydroxamic esters of formula I wherein X is O and R has any one of the meanings detailed above but is different from (i′) and the hydroxamic esters of formula II are especially suitable as photoinitiators for radical photopolymerisation in combination with sensitisers.

In the present text, with the term sensitiser we mean a molecule that, by absorption of UV radiation, does not generate by itself active radicals, but cooperates with the photoinitiator in originating active radical species.

It is therefore a further object of the present invention a photopolymerisable system comprising radically photopolimerizable oligomers and/or monomers having ethylenically unsaturated groups, a sensitiser and, as photoinitiator, at least one hydroxamic esters of formula I, wherein X is O, R has any one of the meanings detailed above but is different from (i′), or at least one hydroxamic ester of formula II.

The sensitisers useful for the present invention are thioxanthone derivatives.

Specific examples of sensitisers suitable for the compositions according to the invention are: thioxanthones, 2-isopropylthioxanthone,2-chlorothioxanthone, 2,4-dimethylthioxanthone, 1-chloro-4-propoxythioxanthone, 2-dodecylthioxanthone, 2,4-diethylthioxanthone, 1-methoxycarbonylthioxanthone, 2-ethoxycabonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 3,4-di-[2-(2-methoxyethoxy)ethoxycarbonyl]-thioxanthone, 1-ethoxycarbonyl-3-(1-methyl-1-morpholinoethyl)-thioxanthone, 2-methyl-6-dimethoxymethyl-thioxanthone.

Thioxanthone, 2-isopropylthioxanthone, 2-chlorothioxanthone, 2,4-dimethylthioxanthone, 1-chloro-4-propoxythioxanthone are the most preferred sensitiser.

The hydroxamic esters of formula I, II and III of the present invention may be prepared by conventional methods which are well known to the man skilled in the art.

By way of example, it is possible to react the acyl chloride of formula R(C═O)Cl with the corresponding hydroxylamine of formula HN(R′)OH in an appropriate solvent, such as methylene chloride, in the presence of a base, such as pyridine or triethylamine; generally the reaction is carried out at a temperature comprised between −10° C. and 45° C., and preferably at room temperature, for a variable time length, that depends on the reactivity of the reactants.

Usually the reaction is completed in 0.5-5 hours. In a second step it is possible to react the hydroxylamine derivative with an acyl chloride to obtain the ester derivatives of formula I.

By way of example, the hydroxamic esters of formula II may be prepared from 2-mercaptopyridine N-oxide sodium salt by reaction with R″(C═O)Cl.

It is a further object of the present invention a process for the realisation of coatings for metal, wood, paper or plastic surfaces, comprising: a) applying the photopolymerisable system containing reactive oligomers and/or monomers having ethylenically unsaturated groups and at least one hydroxamic ester of formula I, II or III; b) photopolymerising with a light source having emission bands in the UV-visible region up to 450 nm, to obtain, after polymerisation, a 0.1 to 100 microns thick coating.

It is a further object of the present invention a process for the preparation of photolithographic images, preferably on metal surface, comprising applying the photopolymerisable system containing reactive oligomers and/or monomers having ethylenically unsaturated groups, a non reactive polymer (by way of example a polyacrylate) and at least an hydroxamic ester of formula I, or II or III. The system may be photopolymerised by a negative film with a light source having emission bands in the UV-visible region up to 450 nm to provide, after suitable development, a 0.1 to 3 micron thick image.

Alternatively the system may be photopolymerised with a laser beam having suitable wave length (for example 405 nm) and power, to provide after suitable development, a 0.1 to 3 micron thick image.

The term “photopolymerisation” is intended in wide sense and include, for example, the polymerisation or crosslinking of polymeric materials, such as for example pre-polymers, the homopolymerisation and the copolymerisation of simple monomers and the combination of this kind of reactions.

Monomers which are useful in the described system include, for example: acrylonitrile, acrylamide and derivatives thereof, vinyl ethers, N-vinylpyrrolidone, mono and polyfunctional allyl ethers, such as for example trimethylolpropane diallylether, styrenes and alpha-methyl styrenes, esters of acrylic and methacrylic acid with alyphatic alcohols, with glycols, or with polyhydroxylated compounds, such as for example pentaerythritol, trimethylolpropane and aminoalcohols, esters of vinyl alcohol with aliphatic or acrylic acids, derivatives of fumaric or maleic acid.

The oligomers which are useful for the present invention include, for example, polyesters, polyacrylates, polyurethanes, epoxidic resins, polyethers with acrylic, maleic or fumaric functionalities.

The hydroxamic esters of formula I, II and III of the present invention acts as photoinitiators and can be used as the sole photoinitiators in the photopolymerisable system of the invention.

In addition to the hydroxamic esters of formula I, II or III, many other components may be included in the photopolymerisable systems of the invention, for example thermal stabilisers, photo-oxydation stabilisers such as sterically hindered amines, antioxidants, oxygen inhibitors, thermal radicals generators such as organic and inorganic peroxides, peresters, hydroperoxides, benzopinacols, azoderivatives such as azodiisobutyronitrile, metallic compounds such as cobalt(II) salts, manganese, antifoams, fillers, dispersing agents, pigments, dyes and/or matting agents, other additives of general use, dispersed solids, glass and carbon fibres, thixotropic agents.

Advantageously, the hydroxamic esters of formula I, II or III, act as photoinitiators even without hydrogen donors, such as thiols and alcohols, in the photocurable composition.

Chemically inert non photopolymerisable polymers, such as nitrocellulose, polyacrylic esters, polyolefines etc., or polymers which are crosslinkables with other systems, as for example with peroxides and atmospheric oxygen or acid catalysis or thermal activation, as for example polyisocyanates, urea, melamine or epoxidic resins are further components that may be included in the photopolymerisable systems.

The compounds of formula I, II or III are generally used in the photopolymerisable system in quantity of 0.01 to 20% by weight, preferably of 1 to 6% by weight, on the total weight of the photopolymerisable system and are perfectly compatible with the system, imparting to it high photochemical reactivity and heat stability.

The compounds of formula I, II or III act as efficient photoinitiators both in clear and non-clear photopolymerisable systems for producing pigmented and non pigmented paints and varnishes and printing inks.

The invention, as described above, provides photoinitiators particularly useful in compositions printing plates, photoresists for electronics, like solder resists, resists to manufacture colour filters for display applications or to generate structures in the manufacturing processes of plasma display panels. Hydroxamic esters of formula II are particularly suitable for the above described use in electronics.

Examples of sources of light useful for the photopolymerisation of the photopolymerisable systems prepared according to the invention are mercury vapour, superactinic, metal-halogen, iron iodide and excimers lamps, led, with emission bands in the UV-visible region and particularly between 180 and 450 nm, and laser having suitable wave length (for example 405 nm) and power.

Examples of the preparation of hydroxamic esters of formula I and II and of photopolymerisable systems containing them are herein reported, as well as photopolymerisation application tests are here reported, not to limit but to illustrate the invention.

### EXAMPLE 1

### N-methyl-N-[(4-(benzoyl)-benzoyl]-O-isobutyryl-hydroxylamine

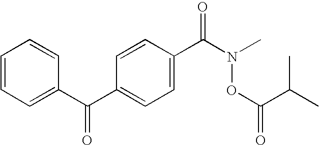

i) Synthesis of N-methyl-N-hydroxy-N-[(4-benzoyl)-benzoyl]-hydroxylamine.

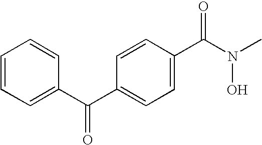

In a three neck spherical reactor equipped with reflux condenser and thermometer, 0.22 g (2.6 mmol) of N-methyl hydroxylamine hydrochloride were suspended in 13 g of dichloromethane. 1.0 g of pyridine was added and then 0.60 g (2.5 mmol) of 4-benzoyl-benzoyl chloride were added in 1 hour in portions. After 1 hour the TLC control showed the acyl chloride consumption. The methylenic phase was washed with a small quantity of 1N HCl and then with an aqueous solution of bicarbonate. After drying the methylenic phase on Na₂SO₄, the solvent was removed under vacuum and the compound purified by flash chromatography (SiO₂, eluent: petroleum ether:ethyl acetate 3:7) to give 0.25 g (39.2%) of an orange oil.

ii) Synthesis of N-methyl-N-[(4-(benzoyl)-benzoyl]-O-isobutyryl-hydroxylamine.

In a three neck spherical reactor equipped with reflux condenser and thermometer, 0.25 g (0.98 mmol) of N-methyl-N-[(4-benzoyl)-benzoyl]-hydroxylamine were dissolved in 10 g of dichloromethane. 0.08 g (1 mmol) of pyridine were added to the solution and then, in 1 hour, at room temperature, drop wise, 0.11 g (1.0 mmol) of isobutyryl chloride in 1 g of dichloromethane were added in 1 hour. The reaction was completed in about 30 minutes; the methylenic solution was poured into water, separated, dried on Na₂SO₄ and purified by flash chromatography (SiO₂, eluent: petroleum ether:ethyl acetate 3:7) to give 0.30 g (94.2% mmol) of a clear oil.

¹HNMR (CDCl₃):δ(ppm): 7.80 (m,4H); 7.76 (d,2H); 7.68 (d, 2H); 7.60 (t, 1H); 7.50 (t,2H); 3.40 (s,3H); 2.5 (m,1H); 0.95 (d,6H).

### EXAMPLE 2

### N-methyl-N-[(2-benzoyl-benzoyl]-O-isobutyryl-hydroxylamine

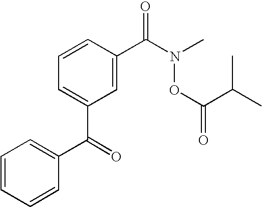

i) Synthesis of N-methyl-N-[(2-benzoyl)-benzoyl]- hydroxylamine

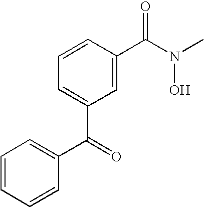

In a three neck spherical reactor equipped with reflux condenser and thermometer, 0.44 g (5.2 mmol) of N-methyl hydroxylamine hydrochloride were suspended in 13 g of dichloromethane. 1.0 g of pyridine was added under stirring and then, in 1 hour portions, 1.20 g (4.9 mmol) of 2-benzoyl-benzoyl chloride were added.

After 1 hour the TLC control showed the acyl chloride consumption. The methylenic phase was washed with a small quantity of 1 N HCl, then with an aqueous solution of bicarbonate, dried on (Na₂SO₄) and the solvent was removed under vacuum. The desired compound was purified by flash chromatography (SiO₂, eluent: dichloromethane:methanol 9:1) to give 0.06 g (4.8%) of an oil.

ii) Synthesis of N-methyl-N-[(4-(benzoyl)-benzoyl]-O-isobutyryl-hydroxylamine.

In a three neck spherical reactor equipped with reflux condenser and thermometer, 0.06 g (2.4 mmol) of N-methyl-N-[(2-benzoyl)-benzoyl]-hydroxylamine are dissolved in 10 g of dichloromethane. 0.02 g (0.25 mmol) of pyridine were added to the solution of then, drop wise, 0.03 g (0.28 mmol) of isobutyryl chloride in 1 g of dichloromethane were added in 1 hour at room temperature.

The reaction was completed in about 60 minutes; the methylenic solution was poured into water, separated, dried on Na₂SO₄ and purified by flash chromatography (SiO2, eluent: dichloromethane:methanol 9:1) to give 0.04 g (52.4%) of a clear oil.

¹HNMR (CDCl₃):δ(ppm): 8.09 (d,1H); 7.80-7.43 (m,8H); 3.08 (s,3H); 2.5 (m,1H); 0.95 (d,6H).

### EXAMPLE 3

### N-methyl-N-(2-naphthyl)-O-isobutyryl-hydroxylamine

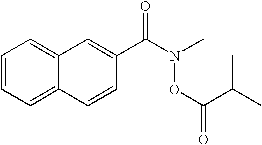

i) Synthesis of N-methyl-N-(2-naphthoyl)-hydroxylamine.

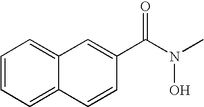

In a three neck spherical reactor equipped with reflux condenser and thermometer, 0.44 g (5.2 mmol) of N-methyl hydroxylamine hydrochloride are suspended at room temperature in 13 g of dichloromethane. 0.46 g (5.7 mmol) of pyridine were added and then 0.93 g (4.90 mmol) of 2-naphthoyl chloride were added in portions in 1 hour at room temperature. After 30 minutes the TLC control showed the acyl chloride consumption. The methylenic phase was washed with a small quantity of 1 N HCl and finally with an aqueous bicarbonate solution. The methylenic phase was dried on Na₂SO₄ and the solvent was removed under vacuum. The desired compound was purified by flash chromatography (SiO₂, eluent: dichloromethane:methanol 9:1) to give 0.40 g (40.6%) of a dark red solid.

ii) Synthesis of N-methyl-N-(2-naphthyl)-O-isobutyryl-hydroxylamine.

In a three neck spherical reactor equipped with reflux condenser and thermometer, 0.40 g (2 mmol) of N-methyl-N-(2-naphthoyl)-hydroxylamine were dissolved in 15 g of dichloromethane. 0.20 g of pyridine (2.5 mmol) were added to the solution and then, drop wise, 0.27 g (2.5 mmol) of isobutyryl chloride in 1 g of dichloromethane were added in 1 hour at room temperature.

The reaction was completed in about 60 minutes; the methylenic phase was poured into water, separated and dried on Na₂SO₄. The solvent was removed under vacuum and the compound purified on flash chromatography (SiO₂, petroleum ether ethyl ecetate 6:4) to give 0.50 g (92.3%) of a clear oil.

¹HNMR (CDCl³):δ(ppm): 8.10 (s,1H); 7.90-7.80 (m,3H); 7.65-7.50 (m,3H); 3.45 (s,3H); 2.45 (m,1H); 0.95 (d,6H).

### EXAMPLE 4

### N-methyl-N-[(9-fluorenone)-2-carbonyl]-O-isobutyryl-hydroxylamine

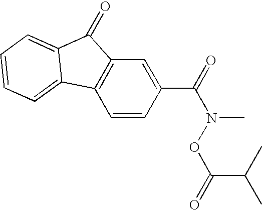

i) Synthesis of N-methyl-N-[(9-fluorenone)-2-carbonyl]-hydroxylamine.

In a three neck spherical reactor equipped with reflux condenser and thermometer, 0.44 g (5.2 mmol) of N-methyl hydroxylamine hydrochloride were suspended in 15 g of dichloromethane. 1.0 g (13 mmol) of pyridine was added under stirring and then 1.0 g (41 mmol) of 9-fluorenone-2-carbonyl chloride were added in portions in 1 hour. After 60 minutes the TLC control showed the acyl chloride consumption. The methylenic phase was washed with a small quantity of 1 N HCl and finally with an aqueous solution of bicarbonate. The methylenic phase is dried on Na₂SO₄ and the solvent was removed under vacuum. The desired compound was purified by flash chromatography (SiO2, eluent: dichloromethane:methanol 9:1) to give 0.78 g (59.3%) of an orange solid.

ii) Synthesis of N-methyl-N-[(9-fluorenone)-2-carbonyl]-O-isobutyryl-hydroxylamine.

In a three neck spherical reactor equipped with reflux condenser and thermometer, 0.78 g (31 mmol) of N-methyl-N-[(9-fluorenone)-2-carbonyl]-hydroxylamine are dissolved in 20 g of dichloromethane. 0.30 g (38 mmol) of pyridine were added to the solution and then 0.36 g (33 mmol) of isobutyryl chloride in 1 g of dichloromethane were added drop wise in 1 hour at room temperature. The reaction was completed in about 30 minutes; the methylenic solution was poured into water, separated and dried on Na₂SO₄ and purified by flash chromatography (SiO₂, dichloromethane:methanol 9:1) to give 0.073 g (73.4%) of a yellow oil.

¹HNMR (CDCl₃):δ(ppm): 7.84 (s,1H); 7.79-7.75 (d,1H); 7.72-7.67 (d,1H); 7.60-7.50 (m,3H); 7.39-7.33 (m,1H); 3.4 (s,3H); 2.5 (m,1H); 0.95 (d,6H).

### EXAMPLE 5

### N-methyl-N-(2-naphthoyl)-O-acetyl-hydroxylamine

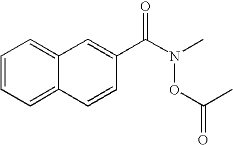

In a three neck spherical reactor equipped with reflux condenser and thermometer 0.83 g (0.0041 mol) of N-methyl-N-(2-naphthoyl)-hydroxylamine were dissolved in 20 g of dichloromethane. 0.60 g (0.0075 mol) of pyridine were added and then, drop wise, 0.35 g (0.0044 mol) of acetyl chloride in 1 g of dichloromethane were added in 1 hour at room temperature.

The reaction was completed in about 60 minutes; the methylenic solution was poured into water, separated dried on Na₂SO₄ and purified by flash chromatography (SiO₂, eluent: petroleum ether:ethyl acetate 6:4) to give 0.50 g (50.2%) of a clear oil.

¹HNMR (CDCl₃):δ(ppm): 8.12 (s,1H); 7.90 (d,1H); 7.85 (m,2H); 7.63 (d, 1H); 7.55 (m, 2H); 3.45 (s,3H); 1.98 (s,3H).

### EXAMPLE 6

### N-methyl-N-(2-thioxanthanoyl)-O-isobutyryl-hydroxylamine

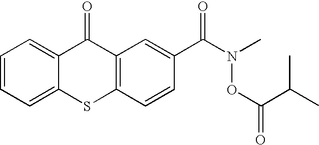

i) Synthesis of N-methyl-N-(2-thioxanthanoyl)-hydroxylamine

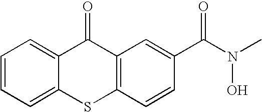

In a three neck spherical reactor equipped with reflux condenser and thermometer 0.41 g (4.8 mmol) of N-methyl hydroxylamine hydrochloride were suspended in 30 g of dichloromethane. Under stirring 0.88 g (11 mmol) of pyridine were added then, in portions, 1.20 g (4.4 mmol) of 2-thioxanthanoyl chloride were added in 1 hour.

After 60 minutes the TLC control showed the acyl chloride consumption. The methylenic phase was washed with a small quantity of 1 N HCl and then with an aqueous solution of bicarbonate. The methylenic phase was dried on Na₂SO₄, the solvent was removed under vacuum and the desired compound purified by flash chromatography (SiO₂, eluent: dichloromethane:methanol 9:1) to give 0.52 g (38.0%) of a light brown solid.

ii) Synthesis of N-methyl-N-(2-thioxanthanoyl)-O-isobutyryl-hydroxylamine

In a three neck spherical reactor equipped with reflux condenser and thermometer 0.30 g (1.1 mol) of N-methyl-N-(2-thioxanthanoyl)-hydroxylamine were dissolved in 20 g of dichloromethane. 0.13 g (1.6 mmol) of pyridine were added to the solution and then, drop wise, 0.12 g (1.2 mmol) of isobutyryl chloride in 1 g of dichloromethane were added in 1 hour at room temperature.

The reaction was completed in about 30 minutes; the methylenic solution was poured into water, separated, dried on Na₂SO₄ and purified by flash chromatography (SiO₂, eluent: petroleum ether:ethyl acetate 7:3) to give 0.36 g (92.2%) of a light yellow solid.

¹HNMR (CDCl₃):δ(ppm): 8.82 (s,1H); 8.62 (d,1H); 7.88 (d,1H); 7.70-7.50 (m,4H); 3.45 (s,3H); 2.5 (m,1H); 0.95 (d,6H).

### EXAMPLE 7

### N-methyl-N-(4-dimethylaminobenzoyl)-O-acetyl-hydroxylamine

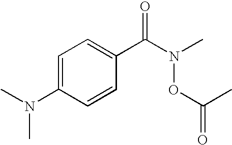

i) N-methyl-N-(4-dimethylamino-benzoyl)-hydroxylamine

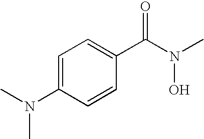

In a three neck spherical reactor equipped with reflux condenser and thermometer 5.31 g (63.6 mmol) of N-methyl-hydroxylamine hydrochloride were suspended at room temperature in 70 g of dichloromethane.

16.7 g (211 mmol) of pyridine were added under stirring and then 11.12 g (61 mmol) of 4-dimethylamine benzoyl chloride were added in portions in 1 hour at room temperature. After 60 minutes the TLC control showed the acyl chloride consumption. The methylenic phase was washed with water and dried on Na₂SO₄; the solvent was removed under vacuum and the desired compound purified by flash chromatography (SiO2, eluent: from dichloromethane:ethyl acetate 95:5 to dichloromethane:ethyl acetate 80:20) to give 7.0 g (56.7%) of a brown solid.

ii) N-methyl-N-(4-dimethylaminobenzoyl)-O-acetyl-hydroxylamine.

In a three neck spherical reactor equipped with reflux condenser and thermometer 7.00 g (39 mmol) of N-methyl-N-(4-dimethylamino-benzoyl)-hydroxylamine were dissolved in 50 g of dichloromethane. 8.05 g (80 mmol) of triethylamine were added and then, drop wise, 3.20 g (41 mmol) of acetyl chloride were added in 1 hour at room temperature.

The reaction was completed in about 60 minutes; the methylenic solution was poured into water, separated, dried on Na₂SO₄ and purified by flash chromatography (SiO₂, eluent: dichloromethane:ethyl acetate 96:4) to give 5.54 g (65.2%) of a light yellow solid.

¹HNMR (CDCl₃):δ(ppm): 7.55 (d,2H); 6.65 (d,2H); 3.48 (s,3H); 3.02 (s,6H); 2.05 (s,3H).

### EXAMPLE 8

### N-methyl-N-(4-dimethylaminobenzoyl)-O-isobutyryl-hydroxylamine

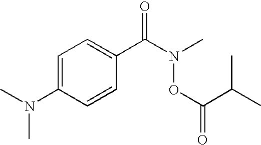

In a three neck spherical reactor equipped with reflux condenser and thermometer 300 mg (1.3 mmol) of N-methyl-N-(4-dimethylamino-benzoyl)-hydroxylamine were dissolved in 7 ml of dichloromethane.

270 mg (2.7 mmol) of triethylamine were added to the solution and then, 125 mg (13 mmol) of isobutyryl chloride were added in 1 hour at room temperature.

The reaction was completed in about 60 minutes; the methylenic solution was poured into water, separated, dried on Na₂SO₄ and purified by flash chromatography (SiO₂, eluent: dichloromethane:methanol 97:3) to give 0.39 g (98.5%) of a light yellow oil.

¹HNMR (CDCl₃):δ(ppm): 7.55 (d,2H); 6.65 (d,2H); 3.38 (s,3H); 3.02 (s,6H); 2.55 (m,1H); 1.10 (d,6H).

### EXAMPLE 9

### N-methyl-N-(4-dimethylaminobenzoyl)-O-pivaloyl-hydroxylamine

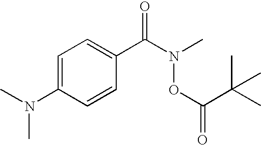

In a three neck spherical reactor equipped with reflux condenser and thermometer, 250 mg (1.3 mmol) of N-methyl-N-(4-dimethylamino-benzoyl)-hydroxylamine were dissolved in 7 ml of dichloromethane.

236 mg of triethylamine were added to the solution and then, drop wise, 141 mg (1.3 mmol) of pivaloyl chloride were added in 30 minutes at room temperature.

The reaction was completed in about 60 minutes; the methylenic solution was poured into water, separated, dried on Na₂SO₄ and purified by flash chromatography (SiO₂, eluent: dichloromethane:methanol 97:3) to give 210 mg (58.1%) of a white solid.

¹HNMR (CDCl₃):δ(ppm): 7.55 (d,2H); 6.65 (d,2H); 3.35 (s,3H); 3.02 (s,6H); 1.13 (s,9H).

### EXAMPLE 10

### N-methyl-N-(4-dimethylaminobenzoyl)-O-3,3-dimethyl-butyroyl-hydroxylamine

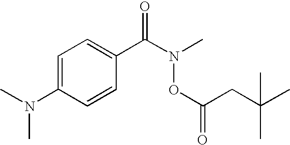

In a three neck spherical reactor equipped with reflux condenser and thermometer, 0.25 g (1.29 mmol) of N-methyl-N-(4-dimethylamino-benzoyl)-hydroxylamine were dissolved in 7 ml of dichloromethane.

140 mg of triethylamine were added and then, drop wise, 0.20 g (1.49 mmol) of 3,3-dimethylbutanoyl chloride were added in 1 hour at room temperature.

The reaction was completed in about 60 minutes; the methylenic solution was poured into water, separated, dried on Na₂SO₄ and purified by flash chromatography (SiO₂, eluent: dichloromethane:methanol 97:3) to give 360 mg g (94.8%) of a light yellow solid.

¹HNMR (CDCl₃):δ(ppm): 7.55 (d,2H); 6.65 (d,2H); 3.35 (s,3H); 3.02 (s,6H); 2.18 (s,2H); 1.00 (s,9H).

### EXAMPLE 11

### N-oxy-isobutirrylpyridine-2-thione

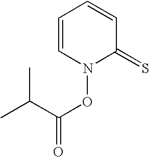

In a three neck spherical reactor equipped with reflux condenser and thermometer, 1.0 g (7.94 mmol) of 2-mercaptopyridine N-oxide were dissolved in 20 ml of dichloromethane.

1.25 ml of triethylamine were added and the temperature was brought to 0° C. 910 ml of isobutyryl chloride were added drop wise.

The reaction was left under stirring for about 60 minutes; the methylenic solution was poured into water, washed with NaHCO₃, separated and dried on Na₂SO₄to give 970 mg (62.0%).

¹HNMR (CDCl₃):δ(ppm): 7.70 (d,1H); 7.55 (d,1H); 7.20 (t,1H); 6.65 (t,1H); 3.00 (m,1H); 1.42 (d,6H).

### EXAMPLE 12

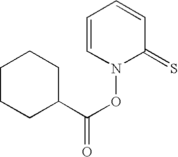

610 ml of triethylamine were added to a well stirred solution of 0.5 g (3.97 mmol) of 2-mercaptopyridine N-oxide in 20 ml of dichloromethane and the temperature was brought to 0° C.; 580 ml (4.34 mmol) of cyclohexanecarbonyl chloride were added drop wise. The mixture was stirred all night at room temperature, poured into water and the organic layer was dried on Na₂SO₄. The solvent was removed under vacuum and the compound purified on flash chromatography (dichloromethane:methanol 97:3) to give 0.50 g (53.1%) of product.

¹HNMR (CDCl₃):δ(ppm): 7.70 (d,1H); 7.55 (d,1H); 7.20 (t,1H); 6.65 (t,1H); 2.75 (m,1H); 2.25-1.20 (m,10H).

### EXAMPLE 13

### N-(4-dimethylaminobenzoyl)-N-methyl-O-2-methylbenzoyl-hydroxylamine

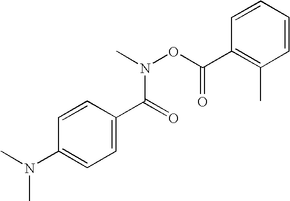

0.43 g (2.78 mmol) of 2-methylbenzoyl chloride were added drop wise to a well stirred solution of 0.51 g (2.63 mmol) of N-methyl-N-(4-dimethylamino-benzoyl)-hydroxylamine in 20 ml of dichloromethane, in 30 minutes at room temperature. The reaction was completed in 120 minutes; the mixture was poured into water and the organic layer was dried on Na₂SO₄. The solvent was removed under vacuum and the compound purified by flash chromatography (dichloromethane:ethyl acetate 95:5) to give 0.21 g (25.6%) of white solid.

¹HNMR (CDCl₃):δ(ppm): 7.8 (d,1H); 7.62 (d,2H); 7.45 (m,1H); 7.23 (m,2H); 6.6 (d,2H); 3.5 (s,3H); 3.0 (s,6H); 2.5 (s,3H). LC/MS (MeOH) [MH]⁺=312.6 m/z

### EXAMPLE 14

### N-(4-dimethylaminobenzoyl)-N-phenyl-O-2-methylbenzoyl-hydroxylamine

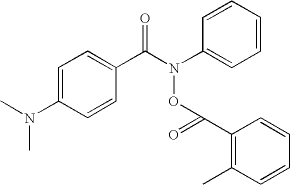

0.18 g (1.17 mmol) of 2-methylbenzoyl chloride were added drop wise to a well stirred solution of 0.20 g (0.78 mmol) of N-hydroxy-N-phenyl (4-dimethylamino)benzamide in 5 ml of dichloromethane, in 60 minutes at room temperature. The reaction was completed in 60 minutes; the mixture was poured into water and the organic layer was dried on Na₂SO₄. The solvent was removed under vacuum and the compound purified by flash chromatography (dichloromethane:ethyl acetate 96:4) to give 0.18 g (61.7%).

¹HNMR (CDCl₃):δ(ppm): 8.0 (d,1H); 7.55 (d,2H); 7.45-7.2 (m,8H); 6.55 (d,2H); 3.5 (s,3H); 2.95 (s,6H); 2.6 (s,3H). LC/MS (MeOH) [MH]⁺=m+/z=374.9

### EXAMPLE 15

### N-(4-dimethylaminobenzoyl)-N-methyl-O-2-biphenylbenzoyl-hydroxylamine

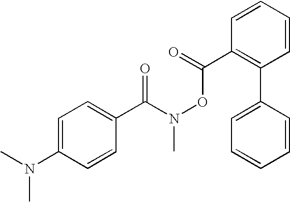

0.737 g (3.402 mmol) of 2-biphenylbenzoyl chloride were added drop wise to a well stirred solution of 0.60 g (3.093 mmol) of N-methyl-N-(4-dimethylamino-benzoyl)-hydroxylamine in 10 ml of dichloromethane, in 60 minutes at room temperature. The reaction was completed in 120 minutes; the mixture was poured into water and the organic layer was dried on Na₂SO₄. The solvent was removed under vacuum and the compound purified by flash chromatography (dichloromethane:ethyl acetate 96:4) to give 0.40 g (34.6%) of a sticky light yellow oil.

¹HNMR (CDCl₃):δ(ppm): 7.7-7.5 (m,4H); 7.4-7.3 (m,5H); 7.15 (t,2H); 6.6 (d, 2H9, 3.2 (s,3H); 3.0 (s,6H). LC/MS (MeOH) [MH]⁺=m+/z=374.7

### EXAMPLE 16

### N-(4-dimethylaminobenzoyl)-N-phenyl-O-2-biphenylbenzoyl-hydroxylamine

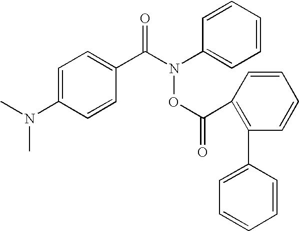

0.28 g (1.29 mmol) of 2-biphenylbenzoyl chloride were added drop wise to a well stirred solution of 0.30 g (1.17 mmol) of N-hydroxy-N-phenyl (4-dimethylamino)benzamide in 10 ml of dichloromethane, in 240 minutes at room temperature. The reaction was completed in 60 minutes; the mixture was poured into water and the organic layer was dried on Na₂SO₄. The solvent was removed under vacuum and the compound purified by flash chromatography (dichloromethane:ethyl acetate 96:4) to give 0.20 g (39.2%) of a light orange solid.

¹HNMR (DMSO):δ(ppm): 7.82 (d,1H); 7.7 (t,1H); 7.57 (t,1H); 7.48 (d,1H); 7.4-7.25 (m,8H); 7.25-7.15 (t,4H); 6.6 (d,2H); 2.92 (s,6H). LC/MS (MeOH) [MH]⁺=m+/z=436.8

### EXAMPLE 17

### N-(4-dimethylaminobenzoyl)-N-methyl-O-2,4,6-trimethylbenzoyl-hydroxylamine

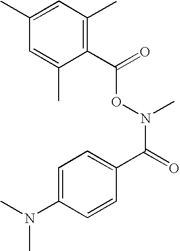

0.52 g (2.84 mmol) of 2,4,6-trimethylbenzoyl chloride were added drop wise to a well stirred solution of 0.51 g (2.63 mmol) of N-methyl-N-(4-dimethylamino-benzoyl)-hydroxylamine in 15 ml of dichloromethane, in 60 minutes at room temperature. The reaction was completed in 120 minutes; the mixture was poured into water and the organic layer was dried on Na₂SO₄. The solvent was removed under vacuum and the compound purified by flash chromatography (dichloromethane:ethyl acetate 95:5) to give 0.40 g (44.7%) of a white solid.

¹HNMR (CDCl₃):δ(ppm): 7.6 (d,2H); 6.8 (s,2H); 6.6 (d,2H); 3.52 (s,3H); 3.0 (s,6H); 2.25 (s,3H); 2.10 (s,6H). LC/MS (MeOH) [MH]⁺=m+/z=340.7

### EXAMPLE 18

### N-(4-dimethylaminobenzoyl)-N-phenyl-O-2,4,6-trimethylbenzoyl-hydroxylamine

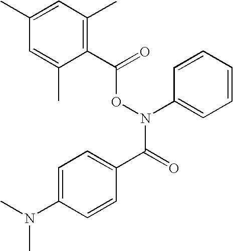

0.15 g (0.82 mmol) of 2,4,6-trimethylbenzoyl chloride were added drop wise to a well stirred solution of 0.20 g (0.78 mmol) of N-hydroxy-N-phenyl(4-dimethylamino)benzamide in 5 ml of dichloromethane, in 60 minutes at room temperature. The reaction was completed in 240 minutes; the mixture was poured into water and the organic layer was dried on Na₂SO₄. The solvent was removed under vacuum and the compound purified by flash chromatography (dichloromethane:ethyl acetate 96:4) to give 0.20 g (6.38%) of product.

¹HNMR (CDCl₃):δ(ppm): 7.52 (d,2H); 7.4-7.2 (m,5H); 6.85 (s,2H); 6.5 (d,2H); 2.98 (s,6H); 2.35-2.25 (9H). LC/MS (MeOH) [MH]⁺=m+/z=403.0

### EXAMPLE 19

### N-methyl-N-(4-dimethylaminobenzoyl)-O-(2-N,N-dimetilamino-isobutyryl)-hydroxylamine

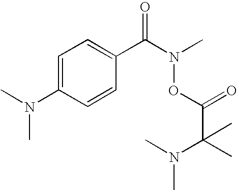

0.58 g (5.7 mmol) of N-methyl morpholine were added to a well stirred solution of 0.50 g (2.99 mmol) of 2-(dimethylamino)-2-methylpropanoic acid hydrochloride in 20 ml of anhydrous tetrahydrofuran, in 60 minutes at room temperature. The temperature was brought to 50° C. and maintained for 30 minutes, then it was lowered to −10° C. and 0.447 mg (3.29 mmol) of isobutyl chloroformate were added. After 10 minutes 0.302 g of triethylamine and 0.617 g (3.18 mmol) of N-methyl-N-(4-dimethylaminobenzoyl)-hydroxylamine were added. After 30 minutes the temperature is allowed to rise until room temperature. The mixture was filtered and cold concentrated and the compound purified on flash chromatography (dichloromethane:ethyl acetate 85:15) to give 0.17 g (18.5%) of a light yellow oil.

¹HNMR (CDCl₃):δ(ppm): 7.55 (d,2H); 6.62 (d,2H); 3.4 (s,3H); 3.0 (s,6H); 2.3 (s,6H); 1.23 (s,6H).

### EXAMPLE 20

### N-methyl-N-[(9-fluorenone)-2-carbonyl]-O-(2-N,N-dimetilamino-isobutyryl)-hydroxylamine

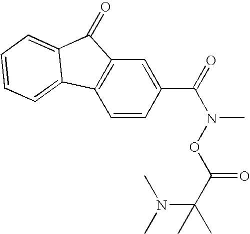

0.72 g of N-methyl morpholine were added to a well stirred solution of 0.60 g (3.58 mmol) of 2-(dimethylamino)-2-methylpropanoic acid hydrochloride in 40 ml of anhydrous tetrahydrofuran. The temperature of this mixture is brought to −10° C. and 0.53 mg (3.8 mmol) of isobutyl chloroformate were added. After 10 minutes 0.36 g of triethylamine and 0.80 g (3.16 mmol) of N-methyl-N-[(9-fluorenone)-2-carbonyl]-hydroxylamine dissolved in 8 g of tetrahydrofuran anhydrous were added. After 30 minutes the temperature is allowed to rise until room temperature and the reaction was completed after 60 minutes. The solvent was removed under vacuum and the compound purified by flash chromatography (dichloromethane:methanol 9:1) to give 0.20 g (17.3%) of product.

¹HNMR (CDCl₃):δ(ppm): 7.85 (s,1H); 7.78 (d,1H); 7.7 (d,1H); 7.6-7.5 (m,3H); 7.38 (t,1H); 3.4 (s,3H); 2.25 (s,6H); 1.2 (s,6H). LC/MS (MeOH) [MH]⁺=m+/z=367.0

### EXAMPLE 21

### N-methyl-N-[(4-benzoyl)-benzoyl)-O-methyl-hydroxylamine

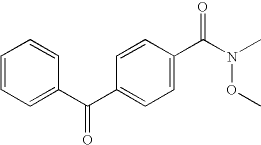

0.14 g of pyridine and 0.36 g (3.69 mmol) of N-methyl-O-methyl hydroxylamine hydrochloride were added to a well stirred solution of 0.43 g (1.75 mol) of 4-benzoyl-benzoyl chloride in 10 g of dichloromethane over 30 minutes at room temperature. After 60 minutes the mixture was poured into water, the organic layer was dried on Na₂SO₄, the solvent was removed under vacuum and the compound purified by flash chromatography (dichloromethane:ethyl acetate 92:8) to give 0.31 g (65.9%) of a white solid.

¹HNMR (CDCl₃):δ(ppm): 7.90-7.75 (m,6H); 7.6 (t,1H); 7.5 (t,2H); 3.58 (s,3H); 3.4 (s,3H).

### EXAMPLE 22

### N-methyl-N-[(2-benzoyl)-benzoyl)-O-methyl-hydroxylamine

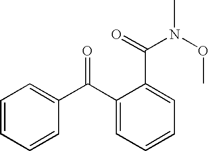

2.42 g of pyridine and 1.42 g (14.56 mmol) of N-methyl-O-methyl hydroxylamine hydrochloride are added to a well stirred solution of 3.25 g (13.29 mmol) of 2-benzoyl-benzoyl chloride in 10 g of dichloromethane over 30 minutes at room temperature. After 60 minutes the mixture was poured into water, the organic layer was dried on Na₂SO₄, the solvent was removed under vacuum and the compound purified on flash chromatography (dichloromethane:ethyl acetate 95:5) to give 1.87 g (52.3%) of a white solid.

¹NNMR (CDCl₃):δ(ppm): 7.8 (d,2H); 7.65-7.4 (m,7H); 3.42 (s,3H); 3.15 (s,3H).

### EXAMPLE 23

### N-(4-dimethylaminobenzoyl)-N-methyl-O-methyl-hydroxylamine

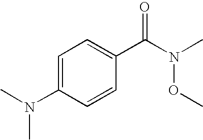

0.96 g of pyridine and 0.65 g (6.67 mmol) of N-methyl-O-methyl hydroxylamine hydrochloride were added to a well stirred suspension of 1.0 g (5.15 mmol) of 4-dimethylamino-benzoyl chloride in 20 ml of dichloromethane over 30 minutes at room temperature. After 60 minutes the mixture was poured into water, the organic layer was dried on Na₂SO₄, the solvent was removed under vacuum and the compound purified by flash chromatography (dichloromethane:ethyl acetate 95:5) to give 0.72 g (67.2%) of a yellow liquid.

¹HNMR (CDCl₃):δ(ppm): 7.75 (d,2H); 6.65 (d,2H); 3.6 (s,3H); 3.35 (s,3H); 3.03 (s,6H).

### EXAMPLE 24

### N-benzoyl-N-methyl-O-methyl-hydroxylamine

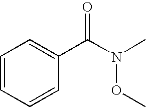

7.0 g of pyridine and 3.56 g (37 mmol) of N-methyl-O-methyl hydroxylamine hydrochloride are added to a well stirred suspension of 5.0 g (36 mmol) of benzoyl chloride in 50 ml of dichloromethane over 30 minutes at room temperature. After 120 minutes the mixture was poured into water, the organic layer was dried on Na₂SO₄, the solvent was removed under vacuum and the compound purified by flash chromatography (dichloromethane:ethyl acetate 95:5) to give 4.56 g (76.8%) of a colourless liquid.

¹HNMR (DMSO):δ(ppm): 7.68 (d,2H); 7.5-7.35 (m,3H); 3.57 (s,3H); 3.35 (s,3H).

### EXAMPLE 25

### N-(4-pirydinoyl)-N-methyl-O-methyl-hydroxylamine

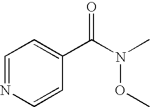

1.93 ml of pyridine then 0.43 g (4.4 mmol) of N-methyl-O-methyl hydroxylamine hydrochloride were added to a well stirred suspension of 0.712 g (4.0 mmol) of isonicotinoyl chloride hydrochloride in 20 ml of dichloromethane over 30 minutes at room temperature. After 60 minutes the mixture was poured into water, the organic layer was dried on Na₂SO₄, the solvent was removed under vacuum and the compound purified by flash chromatography (dichloromethane:ethyl acetate 95:5) to give 0.45 g (67.7%) of a yellow liquid.

¹HNMR (CDCl₃):δ(ppm): 8.54 (d,2H); 7.51 (d,2H); 3.51 (s,3H); 3.35 (s,3H).

### EXAMPLE 26

### N-methyl-N-(2-naphthoyl)-O-methyl-hydroxylamine

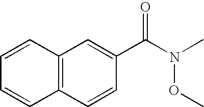

0.90 g of pyridine and 0.57 g (5.843 mmol) of N-methyl-O-methyl hydroxylamine hydrochloride were added to a well stirred solution of 1.0 g (5.25 mmol) of 2-naphthoyl chloride in 20 g of dichloromethane at room temperature. The reaction was completed in 60 minutes; the mixture was poured into water and the organic layer was dried on Na₂SO₄. The solvent was removed under vacuum and the compound purified on flash chromatography (dichloromethane:ethyl acetate 95:5) to give 0.98 g (85.9%) of a colourless oil.

¹HNMR (CDCl₃):δ(ppm): 8.2 (s,1H); 7.95-7.85 (m,3H); 7.75 (d,1H); 7.6-7.5 (m,2H); 3.57 (s,3H); 3.43 (s,3H).

### EXAMPLE 27

### N-methyl-N-(1-naphthoyl)-O-methyl-hydroxylamine

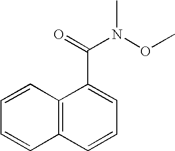

1.0 g of pyridine and 0.57 g (5.84 mmol) of N-methyl-O-methyl hydroxylamine hydrochloride were added to a well stirred solution of 1.0 g (5.25 mmol) of 1-naphthoyl chloride in 15 ml of dichloromethane at room temperature. The reaction was completed in 60 minutes; the mixture was poured into water and the organic layer was dried on Na₂SO₄. The solvent was removed under vacuum and the compound purified by flash chromatography (dichloromethane:ethyl acetate 95:5) to give 0.98 g (86.8%) of solid.

¹HNMR (DMSO-313K):δ(ppm): 8.05-7.95 (m,2H); 7.8-7.7 (m,1H); 7.6-7.5 (m,4H); 3.48 (s,3H); 3.3 (s,3H).

### EXAMPLE 28

### N-methyl-N-(9-antracenoyl)-O-methyl-hydroxylamine

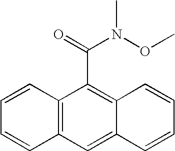

0.425 g of pyridine and 0.255 g (2.62 mmol) of N-methyl-O-methyl hydroxylamine hydrochloride were added to a well stirred solution of 0.6 g (2.49 mmol) of 9-antracencarbinoyl chloride in 15 ml of dichloromethane was added at room temperature. The reaction was completed in 120 minutes; the mixture was poured into water and the organic layer was dried on Na₂SO₄. The solvent was removed under vacuum and the compound purified by flash chromatography (dichloromethane:ethyl acetate 95:5) to give 0.17 g (25.8%) of light yellow solid.

¹HNMR (CDCl₃):δ(ppm): 8.5 (d,1H); 8.1-7.9 (m,4H); 7.6-7.4 (m,4H); 4.15 and 3.65 (s,3H); 3.2 and 2.95 (s,3H).

¹HNMR (DMSO-333K):δ(ppm): 8.65 (s,1H); 8.2-8.1 (m,2H); 7.9-7.8 (m, 2H); 7.65-7.50 (m, 4H); 3.55 (br s, 3H); 3.15 (br s, 3H)

### EXAMPLE 29

### N-methyl-N-(9-acridinoyl)-O-methyl-hydroxylamine

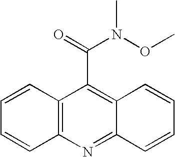

0.17 g of pyridine and 0.12 g (1.23 mmol) of N-methyl-O-methyl hydroxylamine hydrochloride are added to a well stirred solution of 0.22 g (0.91 mmol) of 9-acridinoyl chloride in 10 g of dichloromethane was added at room temperature. The reaction was completed in 120 minutes; the mixture was poured into water and the organic layer was dried on Na₂SO₄. The solvent was removed under vacuum and the compound purified by flash chromatography (dichloromethane:ethyl acetate 9:1) to give 0.18 g (74.3%) of a light yellow solid.

¹HNMR (CDCl₃):δ(ppm): 8.3 (d,2H); 7.95 (d,2H); 7.8 (t,2H); 7.6 (t,2H); 4.15 and 3.65 (s,3H); 3.2 and 2.95 (s,3H).

### EXAMPLE 30

### N-methyl-N-[(9-fluorenone)-2-carbonyl]-O-methyl-hydroxylamine

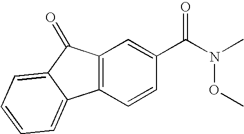

0.17 g of pyridine and 0.092 g (0.94 mmol) of N-methyl-O-methyl hydroxylamine hydrochloride are added to a well stirred solution of 0.216 g (0.89 mmol) of 9-fluorenon-2-carbinoyl chloride in 10 g of dichloromethane was added at room temperature. The reaction was completed in 120 minutes; the mixture was poured into water and the organic layer was dried on Na₂SO₄. The solvent was removed under vacuum and the compound purified by flash chromatography (dichloromethane:ethyl acetate 9:1) to give 0.21 g (88.1%) of a light yellow solid.

¹HNMR (CDCl₃):δ(ppm): 8.0 (s,1H); 7.87 (d,1H); 7.7 (d,1H); 7.6-7.5 (m,3H); 7.38 (t,1H); 3.6 (s,3H); 3.4 (s,3H).

### EXAMPLE 31

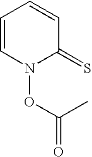

The synthesis is performed under yellow light.

In a three neck spherical reactor equipped with reflux condenser and thermometer 300 mg (1.91 mmol) of 2-mercaptopyridine N-oxide sodium salt are suspended in 5 g of methylene chloride. The reactor is cooled with an ice bath and 179 mg of acetyl chloride (2.28 mmol) are added.

The reaction is left under stirring for about 60 minutes in the ice bath; the methylenic solution was poured into water, separated, washed, dried on Na₂SO₄ and cold concentrated. The reaction product was purified by flash chromatography (SiO₂, eluent: dichloromethane:ethyl acetate 95:5) to give 40 mg (12%) of a greyish-greenish solid.

¹HNMR (CDCl₃):δ(ppm): 7.70 (d,1H); 7.60 (d,12H); 7.25 (t, 1H); 6.65 (t, 1H); 2.45 (s,3H).

### EXAMPLE 32

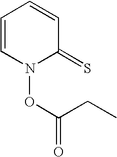

The synthesis is performed under yellow light.

In a three neck spherical reactor equipped with reflux condenser and thermometer 300 mg (1.91 mmol) of 2-mercaptopyridine N-oxide sodium salt are suspended in 5 g of methylene chloride. The reactor is cooled with an ice bath and 200 mg of propionyl chloride (2.16 mmol) are added.

The reaction is left under stirring for about 60 minutes in the ice bath; the methylenic solution was poured into water, separated, washed, dried on Na₂SO₄ and cold concentrated. The reaction product was purified by flash chromatography (SiO₂, eluent: dichloromethane:ethyl acetate 95:5) to give 190 mg (54%) of a dark oil.

¹HNMR (CDCl₃):δ(ppm): 7.70 (d,1H); 7.60 (d,12H); 7.25 (t, 1H); 6.65 (t, 1H); 2.755 (q,2H); 1.33 (t, 3H).

### EXAMPLE 33

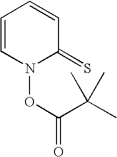

The synthesis is performed under yellow light.

In a three neck spherical reactor equipped with reflux condenser and thermometer 1.85 g (10.8 mmol) of 2-mercaptopyridine N-oxide sodium salt are suspended in 50 g of methylene chloride. 1.30 g of trimethylacetyl chloride (10.6 mmol) are added.

The reaction is left under stirring for about 60 minutes; the methylenic solution was poured into water, separated, washed, dried on Na₂SO₄ and cold concentrated. The reaction product was purified by flash chromatography (SiO₂, eluent: dichloromethane:ethyl acetate 9:1) to give 1.20 g (54%) of a white solid.

¹HNMR (CDCl₃):δ(ppm): 7.70 (d,1H); 7.50 (d,12H); 7.20 (t, 1H); 6.60 (t, 1H); 12.45 (s,9H).

### EXAMPLE 34

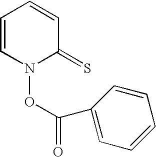

The synthesis is performed under yellow light.

In a three neck spherical reactor equipped with reflux condenser and thermometer 1.50 g (10.0 mmol) of 2-mercaptopyridine N-oxide sodium salt are suspended in 40 g of methylene chloride. The reactor is cooled with an ice bath and 1.45 g of benzoylchloride (13.0 mmol) are slowly added.

The reaction is left under stirring for about 60 minutes; the methylenic solution was poured into water, separated, washed, dried on Na₂SO₄ and cold concentrated. The reaction product was purified by flash chromatography (SiO₂, eluent: dichloromethane) to give 1.38 g (60%) of a light yellow solid.

¹HNMR (CDCl₃):δ(ppm): 8.25 (d,2H); 7.70 (m,3H); 7.55 (m, 2H); 7.23 (t, 1H); 6.70 (t,1H).

### EXAMPLE 35

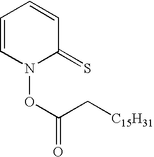

The synthesis is performed under yellow light.

In a three neck spherical reactor equipped with reflux condenser and thermometer 260 mg (1.52 mmol) of 2-mercaptopyridine N-oxide sodium salt are suspended in 10 g of methylene chloride. 470 mg of palmitoyl chloride (1.68 mmol) are added.

The reaction is left under stirring for about 90 minutes; the methylenic solution was poured into water, separated, washed, dried on Na₂SO₄ and cold concentrated. The reaction product was purified by flash chromatography (SiO₂, eluent: dichloromethane:ethyl acetate 9:1) to give 260 mg (47%) of a light yellow solid.

¹HNMR (CDCl₃):δ(ppm): 7.70 (d,1H); 7.55 (d,12H); 7.20 (t, 1H); 6.60 (t, 1H); 2.70 (t,2H); 1.90-1.75 (m, 2H); 1.5-1.2 (m, 26H); 0.9 (t, 3H).

### EXAMPLE 36

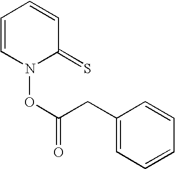

The synthesis is performed under yellow light.

In a three neck spherical reactor equipped with reflux condenser and thermometer 300 mg (1.91 mmol) of 2-mercaptopyridine N-oxide sodium salt are suspended in 5 g of methylene chloride. The reactor is cooled with an ice bath and 340 mg of benzyl chloride (1.95 mmol) are added.

The reaction is left under stirring for about 60 minutes; the methylenic solution was poured into water, separated, washed, dried on Na₂SO₄ and cold concentrated. The reaction product was purified by flash chromatography (SiO₂, eluent: dichloromethane:methanol 8:2) to give 200 mg (47%) of a grey-violet solid.

¹HNMR (CDCl₃):δ(ppm): 8.25 (d,1H); 7.45 (m, 2H); 7.40-7.35 (m, 3H); 7.20-7.10 (m, 2H); 7.05 (m,1H); 4.2 (s, 2H).

### EXAMPLE 37

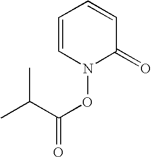

The synthesis is performed under yellow light.

In a three neck spherical reactor equipped with reflux condenser and thermometer 2.0 g (18 mmol) of 1-hydroxy-2-pyridone are suspended in 30 g of methylene chloride and 2.0 g (19.8 mmol) of triethylamine are added.

The reactor is cooled with an ice bath and 2.11 g of isopropyl chloride (19.8 mmol) are added.

The reaction is left under stirring for about 40 minutes in the ice bath and then for 60 minutes at room temperature.

The methylenic solution was poured into water, separated, washed, dried on Na₂SO₄ and cold concentrated. The reaction product was purified by flash chromatography (SiO₂, eluent: dichloromethane:ethyl acetate 9:1) to give 2.6 g (80%) of a yellow oil.

¹HNMR (CDCl₃):δ(ppm): 7.35 (m,2H); 6.70 (d,1H); 6.20 (t, 1H); 2.90-2.80 (m, 1H); 1.35 (d,6H).

### EXAMPLE 38

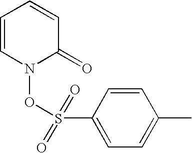

The synthesis is performed under yellow light.

In a three neck spherical reactor equipped with reflux condenser and thermometer 300 mg (2.65 mmol) of 1-hydroxy-2-pyridone are suspended in 10 g of methylene chloride and 250 mg (3.16 mmol) of pyridine are added. 510 mg of p-toluenesulfochloride (2.62 mmol) are added.

The reaction is left under stirring for about 90 minutes; 1.0 g of pyridine is added and stirring is continued for 60 minutes. The methylenic solution was poured into water, separated, washed, dried on Na₂SO₄ and cold concentrated. The reaction product was purified by flash chromatography (SiO₂, eluent: dichloromethane:methano 9:1) to give 660 mg (95%) of a white solid.

¹HNMR (CDCl₃):δ(ppm): 7.90 (d,2H); 7.60 (d,1H); 7.35 (d, 2H); 7.30 (t, 1H); 6.50 (d,1H); 6.15 (t, 1H); 2.45 (s, 3H).

### APPLICATION EXAMPLES

Sensitivity Test.

A photopolymerisable composition is prepared by mixing the following components:

TABLE 0001

| Trade name | Chemical nature | Parts by weight |
|---|---|---|
| Joncryl 683 | polyacrylate | 5.47 |
| DPHA | DPHA* | 5.47 |
| Photoinitiator | | 0.50 |
| Dowanol PM | 1-methoxy-2-propanol | 88.55 |

*DPHA = dipentaerythritol pentaacrylate

The compositions were spread on an anodised aluminium support by a bar coating no. 3. The solvent was removed by heating at 100° C. for 2 minutes in an oven. The thickness of the dry film was approximately 2 micron.

In order to understand if oxygen inhibits the radicals formed by irradiation we added to a some formulation an oxygen scavenger, such as ethyl-4-dimethylbenzoate (EDB) or triphenylphosphine; or, the formulation was covered by film from an aqueous solution of polyvinyl alcohol (PVA) or Carbocel AM 250 (carboxymethylcellulose).

Exposure to light was made by a standardized negative test UGRA Control Wedge 1982 with 13 steps of different optical density (in the range between 0.15 and 1.95) was placed on the surface of dry film.

Exposure was carried out using a metal-halogen 1500 W high pressure (SACK) iron iodide lamp, EL 200411a type, at a distance of 90 cm. Time of exposure was calibrated to reach a total intensity of 1000 mJ/cm².

After exposure, the film was developed with 1% sodium carbonate aqueous solution for 20 sec. at 25° C. by using a spray type developer.

The sensitivity of the different compositions were characterised by indicating the number of the step remained after developing: the higher the number, the more sensitive is the tested composition.

All operation were carried out under yellow light.

The results are listed in Table 1.

TABLE 1

| Photoinitiator | | |
|---|---|---|
| of example | Oxygen inhibitor | Number of the steps |
| Example 6 | Whitout protection | 1 |
| Example 6 | polyvinylalchol | 9 |
| Example 6 | Carbocel AM 250 | 9 |
| Example 6 | EDB + polyvinylalchol | 11 |
| Example 6 | Triphenylphosphine | 3.5 |
| Example 11 | Whitout protection | 9 |
| Example 11 | polyvinylalchol | 13 |
| Example 7* | Whitout protection | 2 |

*in photocurable composition containing also 0.3 parts of isopropyl thioxanthone

Photopolymerisation Experiments

The samples were prepared by dissolving 1% weight of photoinitiator in Ebecryl 605. In some experiments 1% of isopropylthioxanthone (ITX) was also added as sensitiser.

Because of the monomers viscosity, the formulations were heated to 40-50° C. for 15 minutes to 3 hours, in order to complete the dissolution. After 12 hours at room temperature (to remove air bubbles trapped in) the formulations were stored in the refrigerator.

The laminated photopolymerisation reactivity tests were carried out by FTIR in according to the following procedure: a small amount of the formulation is spread between two polypropylene films, in order to suppress the effect of oxygen on the polymerisation, and pressed in order to reach an IR absorption between 1.2 and 1.6 at 1635 cm⁻¹.

The film was then introduced between two BaF₂ windows in a FTIR (Nexus 870, Nicolet). The film was radiated with the Hg—Xe Hamamatsu lamp (10% of the full intensity) for 5 minutes, with a time delay of 2-3 seconds after the beginning of the measure.

The kinetic curves were calculated by integrating the IR band characteristic of an acrylate bond in the monomer between 1625 and 1655 cm⁻¹.

In the Table 2 “Rp” is the rate of polymerisation and “Conv” the quantity of double bond broken and converted in polymer. Rp is the relative rate of polymerisation. The reference was 2,2-dimethoxy-2-phenylacetophenone (DMPA). Rp (DMPA) is taken as 100 in column 1 and 75 in column 2.

The results are listed in Tab. 2 (reporting the rate of polymerisation and conversion of the laminated formulation (without air) and of the formulation in air, crosslinked with the various photoinitiators)

TABLE 2

| | | | | | Sensitiser = ITX | |
|---|---|---|---|---|---|---|
| laminated | | | air | | 1% laminated | |
| Example | Rp | Conv % | Rp | Conv % | Rp | Conv % |
| 1 | 34 | 69 | 28.5 | 47 | 34 | 84 |
| 2 | 6 | 54 | / | / | 13 | 82 |
| 3 | 2 | 28 | / | / | 7 | 80 |
| 4 | 26 | 65 | 18 | 43 | 27 | 79 |
| 5 | 10 | 59 | / | / | 27 | 87 |
| 6 | 61 | 75 | 60 | 81 | 33 | 73 |
| 7 | 4.8 | 57 | 3.2 | 60 | 78 | 86 |
| 8 | 2.1 | 39 | / | / | 70 | 85 |
| 9 | 0.85 | 27 | / | / | 77 | 88 |
| 10 | 1.54 | 36 | / | / | 70 | 86 |
| 11 | 25.3 | 57 | / | / | / | / |
| 12 | / | / | / | / | / | / |
| 13 | / | / | / | / | 49 | 85 |
| 14 | 2.7 | 37 | / | / | / | / |
| 15 | 1.9 | 41 | / | / | 29 | 77 |
| 16 | 1.2 | 31 | / | / | 27 | 77 |
| 17 | / | / | / | / | 64 | 81 |
| 18 | 0.77 | 32 | / | / | 42 | 86 |
| 19 | 1 | 23 | / | / | 65 | 82 |
| 20 | 29 | 70 | 23.2 | 54 | 47 | 70 |
| 21 | 3.4 | 61 | / | / | 10 | 78 |
| 22 | 2.7 | 56 | / | / | 6 | 82 |
| 23 | 0.4 | 23 | / | / | 9 | 85 |
| 24 | / | / | / | / | 8 | 78 |
| 25 | 0.1 | 25 | / | / | 20 | 75 |
| 26 | 1 | 25 | / | / | 8 | 84 |
| 27 | 0.29 | 23 | / | / | 10 | 81 |
| 28 | 0.35 | 56 | / | / | 1 | 70 |
| 29 | 1.75 | 56 | / | / | 1 | 36 |
| 30 | 4.7 | 55 | / | / | 7 | 60 |

From the results of the photopolymerisation experiments, both in coatings and lithography, it is apparent that the compounds of the invention are able to act by themselves as the sole photoinitiators in UV radical polymerisation.

Sensitivity Test of a Resist Formulation.

Some photopolymerisable resist compositions were prepared by mixing the following components:

TABLE 0004

| Name | Chemical nature | Parts by weight |
|---|---|---|
| Polyacrylate-co- | Polyacrylate-co-methacrylate | 7.30 |
| methacrylate | MW = 34000 | |
| BF3713 (20%) | Methacrylate/butylacrylate/ | 18.22 |
| | methacrylic acid | |
| TMPTA | Trimethylolpropane | 10.94 |
| | triacrylate | |
| | Photoinitiator from Example | 0.50 |
| MEK | Methyl ethyl ketone | 31.32 |
| Dowanol PM | 1-methoxy-2-propanol | 31.32 |

The compositions were spread on an anodised aluminium support by a bar coating no. 2. The solvent was removed by heating at 80° C. for 2 minutes in an oven. The thickness of the dry film was approximately 3 micron.

A standardized negative test film UGRA Control Wedge 1982 with 13 steps of different optical density (in the range between 0.15 and 1.95) was placed on the surface of dry film.

Exposure was carried out using a metal-halogen 1500 W high pressure (SACK) iron iodide lamp, EL 200411a type, at a distance of 90 cm.

Time of exposure was calibrated to reach a total intensity of about 500 mJ/cm².

After exposure, the film was developed with an aqueous solution of sodium lauryl sulphate, 2-phenoxyethanol, nonanoic acid diethanolamine salt, for 20 sec. at 25° C. by dipping.

The sensitivity of the different compositions was characterised by the number of the steps: the higher the number, the more sensitive is the tested composition. All operation were carried out under yellow light.

Where reported, a 7.5% PVA aqueous solution was used to inhibit oxygen. The results are listed in Table 3.

TABLE 3

| | Number | Number |
|---|---|---|
| | of steps | of steps |
| Photoinitiator | without PVA | with PVA |
| from Ex. 34 | // | 5 |
| from Ex. 33 | 3-4 | 5 |
| from Ex. 35 | 1 | 6 |
| from Ex. 11 | 3-4 | 9 |
| IRG OXE01* | 2-3 | 5 |

*keto-oxime photoinitiator from Ciba

Photolysis Experiments at Different Wave Lengths

Photolysis with medium pressure Hg lamp (80 W/cm², distance=30 cm): 120 ml of a 6.58*10⁻⁵ M acetonitrile solution of the photoinitiator of Example 11 were exposed to the medium pressure Hg lamp, for variable lengths of time (from 1 to 5 minutes).

In Table 4 the decay of absorbance at 288.91 and 362.93 nm is reported

TABLE 4

| Time (seconds) | Absorbance at 288.91 nm | Absorbance at 362.93 nm |
|---|---|---|
| 0 | 0.83295 | 0.35931 |
| 60 | 0.20240 | 0.008476 |
| 120 | 0.20112 | 0.017040 |
| 180 | 0.19588 | 0.021874 |
| 300 | 0.16415 | 0.027245 |

Photolysis with metal halogen lamp (1500 W/cm², distance=90 cm):

120 ml of a 6.294*10⁻⁵ M acetonitrile solution of the photoinitiator of

Example 11 were exposed to the metal halogen lamp, for variable lengths of time (from 5 to 90 seconds), to annul the absorbance at 363 nm.

In the meantime it is observed that the absorbance at 288 nm shows a little ipso-chromic effect and sensibly decays. After 90 seconds the absorbance at 363 has completely disappeared. In Table 5 the decay of absorbance of the peaks at about 288 and about 362 nm is reported.

TABLE 5

| | Peak at about 288 nm | | Peak at about 362 nm | |
|---|---|---|---|---|
| Time | Max wave | | Max wave | |
| (seconds) | length (nm) | Absorbance | length (nm) | Absorbance |
| 0 | 288.70 | 0.83775 | 363.04 | 0.32691 |
| 5 | 288.95 | 0.73257 | 363.00 | 0.30489 |
| 20 | 288.07 | 0.63668 | 362.16 | 0.24401 |
| 30 | 286.75 | 0.62739 | 363.02 | 0.18873 |
| 40 | 285.66 | 0.55002 | 363.91 | 0.14209 |
| 50 | 283.92 | 0.49897 | 363.91 | 0.09438 |
| 60 | 281.98 | 0.42361 | 363.91 | 0.04822 |
| 90 | 279.14 | 0.25139 | 363.91 | 0.00 |

Photolysis with metal halogen lamp (1500 W/cm², distance=90 cm), filtered with a 2A Filter (Wratten gelatine filter-Kodak No. 2A):

120 ml of a 6.92*10⁻⁵ M acetonitrile solution of the photoinitiator of Example 11 were exposed to the filtered metal halogen lamp, for variable lengths of time (from 40 to 160 seconds). In Table 6 the decay of absorbance of the peaks at about 288 and about 362 nm is reported.

TABLE 6

| | Peak at about 288 nm | | Peak at about 362 nm | |
|---|---|---|---|---|
| Time | Max wave | | Max wave | |
| (seconds) | length (nm) | Absorbance | length (nm) | Absorbance |
| 0 | 288.89 | 0.89342 | 362.98 | 0.35520 |
| 40 | 289.02 | 0.81974 | 363.05 | 0.33382 |
| 80 | 288.75 | 0.75714 | 363.89 | 0.29663 |
| 120 | 288.12 | 0.67388 | 363.66 | 0.24876 |
| 160 | 287.02 | 0.60529 | 363.63 | 0.19699 |

Photolysis with metal halogen lamp (1500 W/cm², distance=90 cm), filtered with a 36W Filter (Wratten gelatine filter-Kodak No. 36):

120 ml of a 6.721*10⁻⁵ M acetonitrile solution of the photoinitiator of Example 11 were exposed to the filtered metal halogen lamp, for variable lengths of time (from 30 to 270 seconds). In Table 7 the decay of absorbance of the peaks at about 288 and about 362 nm is reported.

TABLE 7

| | Peak at about 288 nm | | Peak at about 362 nm | |
|---|---|---|---|---|
| Time | Max wave | | Max wave | |
| (seconds) | length (nm) | Absorbance | length (nm) | Absorbance |
| 0 | 289.21 | 0.89015 | 362.90 | 0.38638 |
| 30 | 289.14 | 0.83607 | 363.79 | 0.35032 |
| 60 | 288.93 | 0.79004 | 363.99 | 0.32214 |
| 90 | 288.59 | 0.74891 | 363.87 | 0.29921 |
| 120 | 288.38 | 0.71419 | 363.91 | 0.27878 |
| 150 | 287.97 | 0.65828 | 363.14 | 0.24490 |
| 180 | 287.60 | 0.65312 | 363.92 | 0.23424 |
| 210 | 287.22 | 0.58655 | 363.89 | 0.20250 |
| 240 | 286.63 | 0.54797 | 364.00 | 0.17912 |
| 270 | 286.64 | 0.54675 | 363.31 | 0.17683 |

1-16. (canceled)

17. A photopolymerizable system comprising radically photopolymerizable oligomers and/or monomers having ethylenically unsaturated groups and, as a photoinitiator, at least one hydroxamic esters of formula I or II or III: 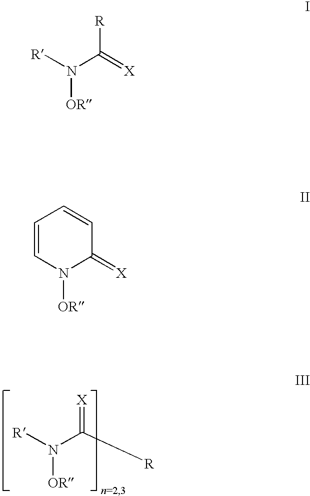
Wherein:
X is 0 or S; and
R is:
(i) phenyl;
(ii) phenyl which is substituted with one or more C₁-C₁₂ linear or branched alkyl or cycloalkyl, C₁-C₄ haloalkyl, halogen, nit R₀, cyano, phenyl, benzyl, O R₀, N R₁R₂, SR₃, benzoyl, S(═O)-phenyl, S(═O)₂-phenyl and/or S-phenyl,
the substituents, OR₀, NR₁R₂, and SR₃ possibly forming 5- or 6-membered rings, via the radicals R₀, R₁, R₂, and/or R₃, or with further substituents on the phenyl ring or with one of the carbon atoms of the phenyl ring; 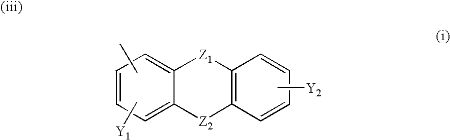
where Z₁ and Z₂ are, independently of each other, a single bond, S, O, S═O, S(═O)₂, C═O, C═S, NR₁, C(═N)R₁, C₁-C₂ alkylene which is unsubstituted or substituted with C₁-C₁₂ alkyl, and
Y₁ and Y₂, are, independently of each other, C₁-C₁₂ linear or branched alkyl, C₁-C₄ haloalkyl, cycloalkyl, halogen, phenyl, benzyl, OR₀, NR₁R₂, SR₃, benzoyl, S(═O)-phenyl, S(═O)₂-phenyl and/or S-phenyl,
the substituents OR₀, NR₁R₂, SR₃ possibly forming 5- or 6-membered rings via the radicals R₀, R₁, R₂ and/or R₃, or with further substituents on the phenyl ring or with one of the carbon atoms of the phenyl ring, and
the radicals C₁-C₁₂ alkyl, C₁-C₄ haloalkyl, phenyl possibly being substituted with a (C═O)N(R′)OR″ group;
(iv) naphthyl, anthracyl, phenanthryl, the radicals naphthyl, anthracyl and phenanthryl being unsubstituted or substituted with one or more C₁-C₆ linear or branched alkyl or cycloalkyl, phenyl, OR₀, NR₁R₂, SR₃ and/or S-phenyl,
the substituents OR₀, NR₁R₂, SR₃ possibly forming 5- or 6-membered rings, via the radicals R₀, R₁, R₂ and/or R3, or with further substituents on the naphthyl, anthracyl or phenanthryl ring or with one of the carbon atoms of the naphthyl, anthracyl or phenanthryl ring; or
(v) a 5- or 6-membered heterocyclic unsaturated radical comprising one or two heteroatoms selected from 0, S and N, which is unsubstituted or substituted with C₁-C₆ alkyl, phenyl, OR₀, NR₁R₂, SR₃ and/or S-phenyl,
the substituents OR₀, NR₁R₂, SR₃ possibly forming 5- or 6-membered rings via the radicals R₀, R₁, R₂ and/or R3 or with further substituents on the heterocyclic unsaturated radical or with one of the carbon atoms of the heterocyclic unsaturated radical;
R′ is:
(i) a C₁-C₁₂ linear or branched alkyl group or cycloalkyl which is unsubstituted or substituted with OH, C₁-C₄ alkoxy, SH, NR₁R₂ phenyl, benzyl, benzoyl, C₁-C₁₂ alkylsulfonyl, phenylsulfonyl, (4-methylphenyl)sulfonyl and/or C₁-C₆ alkanoyl, or C₅-C₆ cycloalkyl;
(ii) C₂-C₁₂ alkyl interrupted by one or more -0-, said interrupted C₁-C₁₂ alkyl being unsubstituted or substituted with OH, C₁-C₄ alkoxy, C₁-C₁₂ alkylsulfonyl, phenylsulfonyl, (4-methylphenyl) sulfonyl and/or C₁-C₆ alkanoyl; or
(iii) phenyl, or phenyl which is substituted with one or more C₁-C₁₂ alkyl, C₅-C₈ cycloalkyl , C₁-C₄ haloalkyl, halogen, phenyl, OR₀, NR₁R₂, SR₃, benzoyl, S(═O)-phenyl, S(═O)₂-phenyl and/or S-phenyl,
the substituents OR₀, NR₁R₂, SR₃ possibly forming 5- or 6-membered rings, via the radicals R₀, R₁, R₂ and/or R3, or with further substituents on the phenyl ring or with one of the carbon atoms of the phenyl ring;
R″ is:
(i) R′; or
(ii) (C═O)R′″;
wherein:
R′″ is:
(i) R′; or
(ii) C₁₃-C₁₈ linear or branched alkyl group or cycloalkyl, or R″ is a C₁-C₁8 linear or branched alkyl sulfochloride or cycloalkyl sulfochloride or phenyl sulfochloride wherein the phenyl is unsubstituted or substituted with one or more C₁-C₁₂ alkyl, C₅-C₈ cycloalkyl, C₁-C₄ haloalkyl, halogen, phenyl, OR₀, NR₁R₂, SR₃, benzoyl and S-phenyl;
R₀ is:
(i) hydrogen, phenyl, benzyl, C₁-C₁₂ alkyl unsubstituted or substituted with phenyl, benzyl, benzoyl, OH, C₁-C₁₂ alkoxy, C₁-C₁₂ alkylsulfonyl, phenylsulfonyl, (4-methylphenyl)sulfonyl and/or by C₂-C₆ alkanoyl; or
(ii) C₂-C₁₂ alkyl interrupted by one or more -0-, said interrupted C₂-C₁₂ alkyl being unsubstituted or substituted with phenyl, OH, C₁-C₁₂ alkoxy, C₁-C₁₂ alkylsulfonyl, phenylsulfonyl, (4-methylphenyl)sulfonyl and/or by C₂-C₆ alkanoyl;
R₁ and R₂ independently of one another are
(i) hydrogen, C₁-C₁₂ alkyl which is unsubstituted or substituted by OH, C₁-C₄ alkoxy, C₁-C₁₂ alkylsulfonyl, phenylsulfonyl, (4-methylphenyl)sulfonyl and/or C₁-C₆ alkanoyl;
(ii) C₂-C₁₂ alkyl or cycloalkyl interrupted by one or more -0-, said interrupted C₂-C₁₂ alkyl being unsubstituted or substituted with OH, C₁-C₄ alkoxy, C₁-C₁₂alkylsulfonyl, phenylsulfonyl, (4-methylphenyl)sulfonyl and/or C₁-C₆ alkanoyl;
(iii) phenyl, C₂-C₆ alkanoyl, benzoyl, C₁-C₆ alkylsulfonyl, phenylsulfonyl, (4-methylphenyl)sulfonyl, naphthylsulfonyl, anthracylsulfonyl or phenanthrylsulfonyl, or
(iv) together with the nitrogen atom to which they are bonded, form a 5-, 6- or 7-membered ring which may be interrupted by -0-, —S— or by —NR₀;
R3 is:
(i) C₁-C₁₂ alkyl which is unsubstituted or substituted with OH and/or C₁-C₄ alkoxy; or
(ii) R3 is C₂-C₁₂ alkyl interrupted by one or more -0-, said interrupted C₂-C₁₂ alkyl being unsubstituted or substituted with OH and/or C₁-C₄ alkoxy.

18. The photopolymerizable systems according to claim 17, wherein the hydroxamic esters of formula I, II or III are the sole photoinitiators in the system.

19. The photopolymerizable system according to claim 17 comprising as photoinitiator, at least one hydroxamic ester of formula I wherein X is 0.

20. The photopolymerizable system according to claim 17 comprising as photoinitiator, at least one hydroxamic ester of formula II wherein X is S.

21. The photopolymerizable systems according to claim 17, wherein the photoinitiator is an hydroxamic ester of formula I where R is 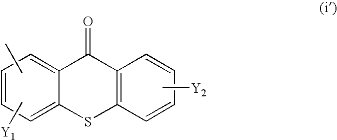
and Y₁ and Y₂, are independently of each other C₁-C₁₂ linear 0 branched alkyl, C₁-C₄ haloalkyl, cycloalkyl, halogen, phenyl, or OR₀.

22. The photopolymerizable systems according to claim 17, wherein the photoinitiator is a hydroxamic ester of formula II wherein R″ is (C═O)R′″, with R′″ being C3-C₆ secondary alkyl or C5-C₆ cycloalkyl.

23. A photopolymerizable system comprising
oligomers and/or monomers including ethylenically unsaturated groups, at least a sensitizer chosen from thioxanthone and thioxanthone derivatives, and as photoinitiator,
at least one hydroxamic esters of formula I, wherein X is 0 and R is different from (i′), or
at least one hydroxamic esters of formula II.

24. The photopolymerizable system according to claim 23, where the sensitizer is chosen from: thioxanthones, 2-isopropylthioxanthone, 2-chlorothioxanthone, 2,4-dimethylthioxanthone, 1-chloro-4-propoxythioxanthone, 2-dodecylthioxanthone, 2,4-diethylthioxanthone, 1-methoxycarbonylthioxanthone, 2-ethoxycarbonylthioxanthone, 3-(2-methoxyethoxycarbonyl)-thioxanthone , 4-butoxycarbonylthioxanthone, 3-butoxycarbonyl-7 -methylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 3,4-di-[2-(2-methoxyethoxy ethoxycarbonyl]-thioxanthone, 1-ethoxycarbonyl-3-(1-methyl-1-morpholinoethyl)-thioxanthone, and 2-methyl-6-dimethoxymethyl-thioxanthone.

25. The photopolymerizable system according to claim 24, where the sensitizer is chosen from thioxanthone, 2-isopropylthioxanthone, 2-chlorothioxanthone, 2,4-dimethylthioxanthone, and 1-chloro-4-propoxythioxanthone.

26. Compounds of formula I wherein X is 0, R is (i′) and Y₁ and Y₂ are, independently of each other, C₁-C₁₂ linear 0 branched alkyl, C₁-C₄ haloalkyl, cycloalkyl, halogen, phenyl, or OR₀.
